(19) United States
(12) Patent Application Publication
(10) Pub. No.: US 2011/0025745 A1
(43) Pub. Date: Feb. 3, 2011

(54) Method for Applying an Undercoat in an Ink Jet Recording Apparatus

(76) Inventors: Hideo Izawa, Chiba (JP); Takashi Kurosawa, Chiba (JP); Hideo Yamada, Chiba (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/936,343

(22) PCT Filed: Mar. 27, 2009
(86) PCT No.: PCT/JP2009/056907

§ 371 Date: Oct. 4, 2010

(30) Foreign Application Priority Data
Apr. 2, 2008 (JP) 2008-095610

(51) Int. Cl. B41J 29/38

(52) U.S. Cl. 347/14

(57) ABSTRACT

It is sought to allow a control unit part to be made up simply and at low cost, to prevent oozing out at an edge portion of a printing image and to enable inkjet printing at high quality regardless of kinds of the recording medium.

To this end, there is provided a method of applying an undercoat in an ink jet recording apparatus of line type for printing recorded information, including an ink jet type undercoating unit for prior undercoating on a recorded information printing portion wherein undercoating data are prepared by software manipulation on the basis of printing information recorded data, characterized in that it comprises: laying a mask beneath a layer of a printing image and detecting an edge of the printing image; and on the basis of a mask information having the printing image extracted by software manipulation, applying an undercoat to an area covering from the printing image to an outer side of an edge portion of the printing image.

### TECHNICAL FIELD

The present invention relates to a method of applying an undercoat in an ink jet recording apparatus in which the undercoat is applied to a recording area of a recording medium prior to ink discharging and a printing on the recording area with an ink jet printer is carried out.

### BACKGROUND ART

In printing on a surface of recording medium with an ink jet recording apparatus, ink discharged from a printing nozzle and adhered to the surface of recording medium might blot on that surface of recording medium, or its droplets might spread wider in area than as necessary, thereby causing printing to become unclear and thus deteriorating printing quality. Thus, to get rid of such inconveniences, exclusive use has hitherto be made as the recording medium of a special or dedicated paper web for ink jet recording which has been processed to apply an undercoat on its entire surfaces, the undercoat having properties that it is good in ink absorption and hard in ink spreadability.

Such prior art requires that printing on even a slight area use a dedicated paper web processed to apply an undercoat to its entire surfaces. Dedicated paper webs further have the problem that they not only are much expensive compared to a general paper web of fine quality but require handling in a increased number of process steps compared to the general paper web both under their storage conditions and in their uses.

To solve these problems, methods of applying an undercoat to an area of recording medium to be printed on with a printing nozzle, prior to ink discharging from the printing nozzle have been known from JP H06-255096 A and JP H08-52868 A.

The undercoating method disclosed in JP H06-255096 A allows an undercoat containing a resin material adapted for printing to be applied to a designated area on a recording medium prior to its recording with recoding ink so that recoding with the recording ink can be effected on an undercoat layer adapted for printing, regardless of kinds of the recording medium used. The method permits inkjet recording of high appearance quality regardless of kinds of the recording medium used.

In such a recording method, however, due to the fact that a recording signal is input to a coating means for application of the undercoat and an output signal of a delay means furnished with the recording signal is input to a recording means for recording, mass data communications in multiple steps are necessary in simultaneous progress with data communication for recording of large amounts of recording data.

And, in such a recording method, if the recording medium to be printed on is a continuous paper web, from the limitation of communication speed the problem arises that a limit of the speed of travel of the continuous paper web comes to be brought about.

Also, as for a control unit for data communications in multiple stages and signal processing, the problem arises that it needs to be larger in capacity and size, becoming uneconomical in respect of its cost.

On the other hand, in a recording method as described in the JP H08-52868 A, an undercoat to be applied prior to printing with a printing head is applied to an inner part of an outermost border of a printing area except at least a portion of the outermost border.

In this prior art, after the undercoat is applied a printing that extends off the outermost border of the undercoat applied area gives rise to the problem that this extending portion becomes a blot on the recording medium.

Made in view of the above, the present invention has for its object to solve the problems in the conventional recording methods and to provide a method of applying an undercoat in an ink jet recording apparatus which allows the control unit part to be made up simply and at low cost, can prevent oozing out at an edge portion of a printing image and allows inkjet printing at high quality regardless of kinds of the recording medium.

### DISCLOSURE OF THE INVENTION

In order to achieve the object mentioned above, there is provided in accordance with the present invention in a first aspect thereof a method of applying an undercoat in an ink jet recording apparatus of line type for printing recorded information, including an ink jet type undercoating unit for prior undercoating on a recorded information printing portion wherein undercoating data are prepared by software manipulation on the basis of printing information recorded data, characterized in that it comprises: laying beneath a layer of a printing image a mask for detecting an edge of the printing image; and on the basis of a mask information having the printing image extracted by software manipulation, applying an undercoat to an area covering from the printing image to an outer side of an edge portion of the printing image.

And, the present invention in a second aspect thereof provides a method of applying an undercoat in an ink jet recording apparatus as set forth above, wherein it comprises: associating the printing image with an image name to allow the printing image on the undercoat being applied to be identified with the image name.

Also, the present invention in a third aspect thereof provides a method of applying an undercoat in an ink jet recording apparatus according to the first aspect above, wherein it comprises: preparing a pattern of undercoat application areas, designating any of the these areas of and, if information is recorded in the designated area, applying the undercoat exclusively on a portion on which the information is recorded. And, the present invention in a fourth aspect thereof provides a method of applying an undercoat in an ink jet recording apparatus according to each preceding aspect of the invention, wherein the undercoat application areas are made adjustable in size.

According to the present invention, the control unit part can be configured simply and at low cost. And, applying an undercoat to an area covering from the printing image to an outer side of an edge portion of the printing image makes it possible to prevent oozing out at the edge portion of a printing image and allows inkjet printing at high quality regardless of kinds of the recording medium.

### BRIEF DESCRIPTION OF THE DRAWINGS

In the Drawings:

FIG. 1 is a work flow diagram of a method of the present invention;

FIGS. 2A, 2B and 2C are diagrams illustrating a process of forming a mask image;

FIG. 3 is an explanatory diagram illustrating the state that a printing image is printed on an undercoat applied portion;

FIG. 4 is an explanatory diagram of a first method of designating an undercoat application area;

FIG. 5 is an explanatory diagram of a second method of designating an undercoat application area; and

FIGS. 6A and 6B show the second method and are explanatory diagrams illustrating an undercoat application area and areas with respect to printing areas in case that undercoating area and areas are printed on, respectively.

### BEST MODES FOR CARRYING OUT THE INVENTION

In the method according to the present invention, undercoat application data are prepared in advance by a program manipulation determined in terms of a software on the basis of recorded data of information, and as a recording medium is driven to travel, an undercoat is applied by an undercoating head on an information recording area based on the undercoat application data and thereafter an undercoat applied portion is successively printed on by printing heads for respective colors. In this case, the undercoat application area is designed to be slightly larger than an area of printing by the printing head and printing is to be effected at the inner side of the undercoat application area.

According to this method in which both information recording and undercoat application are effected directly on the recording medium by respective printing heads based on printing data, communication data for both the recording and application are reduced in amount, thereby to enable processing higher in speed. In addition, both recording and application are enabled with a control unit smaller in capacity while enabling information of high quality to be recorded with an apparatus simple in structure and lower in cost.

The present invention may, in flow from data entry up to printing, comprise: (1) selecting an original image intended for undercoat application; (2) determining an undercoat application area; (3) in dividing printing data for the original image into data for individual colors, extracting mask information for the undercoat application to prepare data for the undercoat application; and (4) transferring data for the undercoat application and the data for the colors to an undercoating head and printing heads for the colors, respectively, to apply the undercoat to the determined area and to print the original image in the determined area. Parenthetically, the amount of application of the undercoat can then be adjusted at the transfer side.

As for contents of specific processing on a program, the undercoat application data is prepared according to contents as set forth below.

First, beneath an area of an original image (printing image) a mask (a layer of special color) is laid for detecting an edge of the printing image (printing portion), and in separating printing data into data for individual colors (K, C, M, Y) the printing portion is extracted from the mask.

On the basis of the mask information acquired in this way, an undercoat application area is determined by designating, by a program, how many pixel portions adjacent to an edge portion of the mask information the undercoat is to be applied to.

As a first method of designating the undercoat application area there is a method which comprises associating the printing image with an image name to allow the printing image on the undercoat being applied to be identified with the image name so as to make a mask information with respect to the printing image whereby if the position at which or the page on which the printing image is recorded is variable, the undercoat can be applied by the mask information accordingly.

As a second method of designating the undercoat application area there is a method of preparing undercoat application data by a program, which comprises preparing a pattern of undercoat application areas and designating any of these areas whereby, if information is recorded (printed) in the designated area, the undercoat can be applied exclusively on a portion on which the information is recorded.

Also, the two methods above may be used in combination with preference given to the printing image designation or the printing area designation to prepare the recorded data of undercoat application.

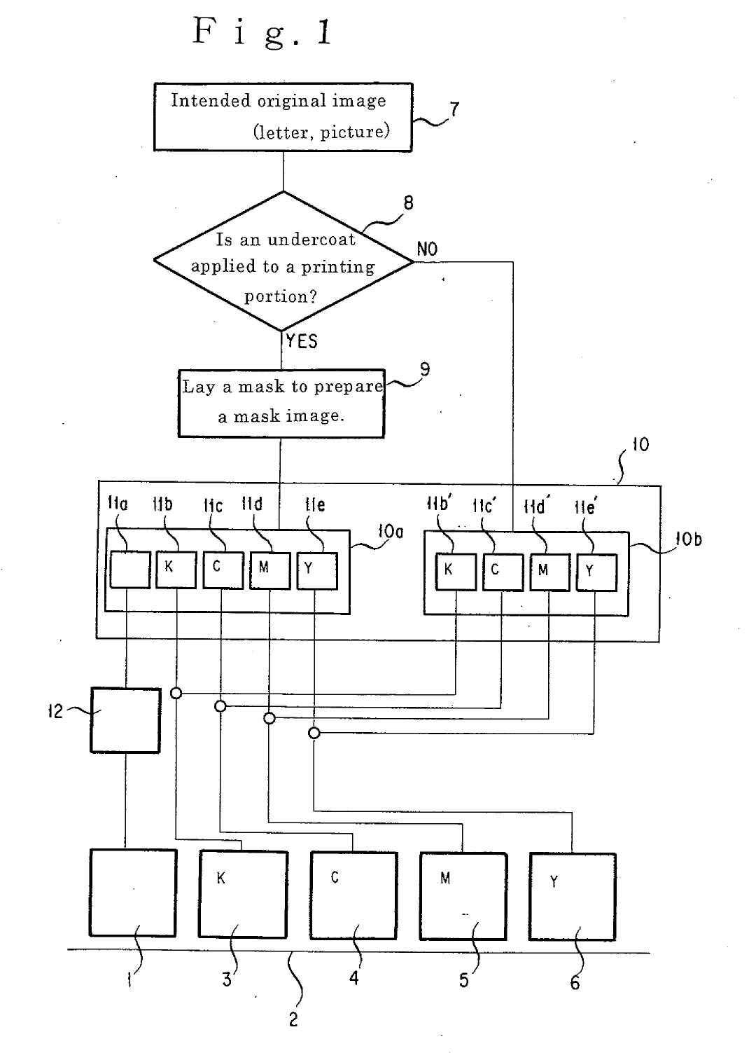

Referring now to FIG. 1, mention is made of a first form of implementation of the present invention. In FIG. 1 there are shown an undercoating head 1 for applying an undercoat on a recording medium 2 and four color printing heads 3, 4, 5 and 6, namely 3 for K (black), 4 for C (cyan), 5 for M (magenta) and 6 for Y (yellow), successively arranged towards downstream in the direction of travel of the recording medium 2 with respect to the undercoating head 1. And, the undercoating head 1 and the respective printing heads 3, 4, 5 and 6 are designed to operate following a work flow diagram shown in FIG. 1.

Specifically, numeral 7 denotes a program manipulation section that outputs printing data by a program manipulation determined in terms of a software on the basis of recoding data of information about an intended printing image such as a letter or picture.

Numeral 8 denotes an undercoat application judging section for the printing data from the program manipulation section 7 to judge if or not an undercoat is to be applied to a printing portion by printing data.

Numeral 9 denotes a mask image preparing section which in response to an input of printing data which indicates a judgment by the undercoat application judging section 8 that the undercoat is to be applied, lays a mask on the printing data to form a mask image.

Numeral 10 denotes a separating data processing section that prepares undercoating data from the mask image information and at the same time separates the printing data into data for individual colors to transmit the undercoating data and the separated data to the undercoating head 1 and the printing heads 3 to 6, respectively. The separating data processing section 10 has an undercoating part 10a and a non-undercoating part 10b. And, the undercoating part 10a has an undercoating signal output part 11a for furnishing the undercoating head 1 with an undercoating signal and printing signal output parts 11b, 11c, 11d and 11e for furnishing the printing heads 3, 4, 5 and 6 with printing signals for the individual colors. On the other hand, the non-undercoating part 10b has printing signal output parts 11b′, 11c′, 11d′ and 11e′ for furnishing the printing heads 3, 4, 5 and 6 with printing signals for the individual colors.

The undercoating signal (data) from the undercoating signal output part 11a in the undercoating part 10a is to be furnished into the undercoating head 1 after the size of the undercoating area relative to that of the printing area is determined by an undercoating area determining section 12.

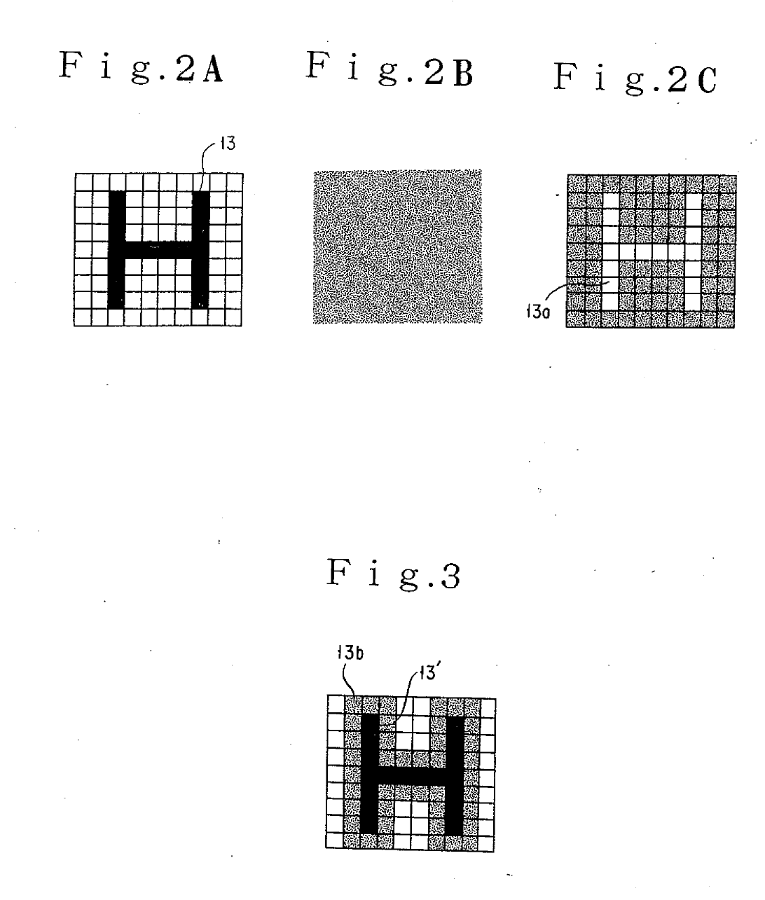

FIGS. 2A, 2B and 2C show a process of forming a mask image (information) for determining an area in which an undercoat is applied with respect to an area in which printing is effected. First, in the program manipulation section 7 in FIG. 1, an original image 13 “H” for which the undercoat is applied is defined (FIG. 2A). Next, it is determined in the undercoat application judging section 8 if an undercoat is applied for the original image 13 “H” or not. If the undercoat is determined to be applied, it is determined in the mask image preparing section 9 that a mask is laid on a portion in which the “H” is to be printed (FIG. 2B). Then, as shown in FIG. 2C, an edge image 13a of the original image 13 is detected under a layer of the original image 13. And, the edge image 13a is input to the undercoating signal output part 11a of the undercoating part 10a in the separating data processing section 10.

In the undercoating signal output part 11a, the edge image 13a obtained in the process above and shown in FIG. 2C is processed to determine pixel portions in and around the edge image 13a as an undercoating (undercoat application) area by means of a software. And, a resulting undercoat application area signal is fed to the undercoating head 1 whereby as shown in FIG. 3 an undercoat is applied to the edge image 13a and an undercoating area 13b around the edge image 13a, and after that a print image 13′ is printed thereon by a printing head.

Signals from the undercoating signal output part 11a are processed by means of a software at the undercoating area determining section 12 thereby to allow the size of the undercoating area to be varied according to the nature or the like of a recording medium to which the undercoat is to be applied. Specifically, designating by the program how many (or the number of) those pixel portions adjacent to the edge portion of mask information up to which the undercoating is to extend allows the undercoating area to be determined, depending on the nature or the like of the recording medium.

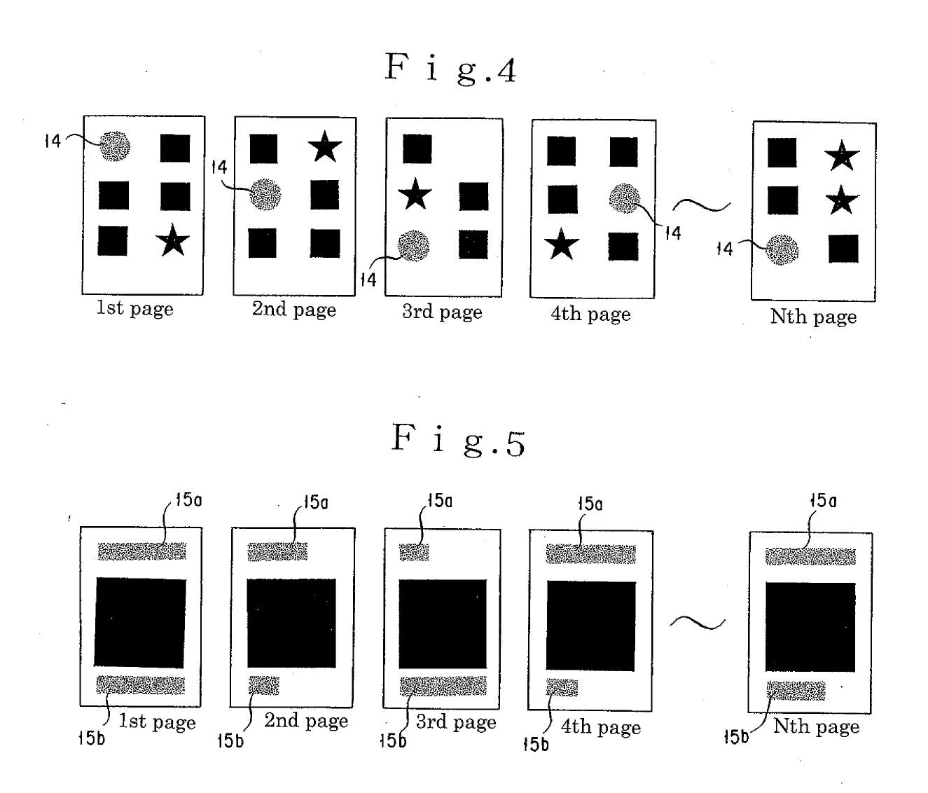

FIG. 4 is a diagram illustrating a first method of designating an undercoating area as mentioned above. In this method, an association is established with printing images for undercoat application whereby undercoating can be applied not to a fixed area on each of a plurality of pages of recording medium but to a particular designated printing image 14 varied in location for each of the pages. The method can thereby eliminate futile application of undercoats.

FIG. 5 is a diagram illustrating a second method of designating an undercoating area as mentioned above. In this method, undercoating is not associated with a printing image but can be applied only with respect to an object which is in an area to which undercoating is applied. On each of a plurality of pages of recording medium there are designated, e.g., at, an upper and a lower side thereof, undercoating areas 15a and 15b which vary in size. And, undercoating is not applied to a portion where an object to be recorded (printing) is not present in each of these areas.

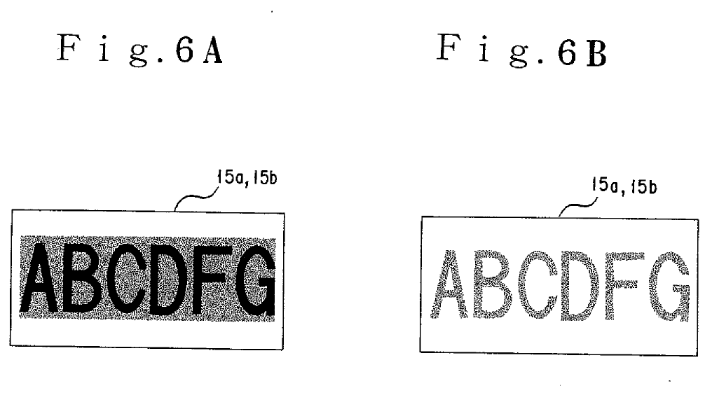

FIGS. 6A and 6B show the second method mentioned above in which an object (printing) is present in the undercoating area 15a, 15b. FIG. 6A shows the case that an undercoat is applied covering a plurality of printing letters as a whole in the undercoating area 15a, 15b. FIG. 6B shows the case that an undercoat is applied for each of a plurality of printing letters in the undercoating area 15a, 15b.

Designating exclusively a printing image necessary for undercoating or a recorded information printing portion necessary for undercoating in this manner makes it possible to avoid undercoating unnecessary portions and thereby enables production at low cost and outstanding in economy.

Also, preparing recorded data for undercoating by software to apply an undercoat by such exclusive data for undercoating renders printing efficient in economy and high in speed and makes it possible for an operator to freely designate the undercoating area and printing image by means of a software and to effect changeover in setting into a variety of commodity products by means of a simple system, while providing the system that is easy to use in serviceability.

1. A method of applying an undercoat in an ink jet recording apparatus of line type for printing recorded information, including an ink jet undercoating unit for prior undercoating on a recorded information printing portion wherein undercoating data are prepared by software manipulation on the basis of printing information recorded data, wherein the method comprises the steps of:
laying beneath a layer of a printing image a mask for detecting an edge of the printing image; and
on the basis of a mask information having the printing image extracted by software manipulation, applying an undercoat to an area covering from the printing image to an outer side of an edge portion of the printing image.

2. The method of applying an undercoat in an ink jet recording apparatus as set forth in claim 1, further comprising the steps of
associating the printing image with an image name to allow the printing image on the undercoat being applied to be identified with the image name.

3. The method of applying an undercoat in an ink jet recording apparatus as set forth in claim 1, further comprising the steps of: preparing a pattern of undercoat application areas, designating any of said areas and, if information is recorded in the designated area, applying the undercoat exclusively on a portion on which the information is recorded.

4. The method of applying an undercoat in an ink jet recording apparatus as set forth in claim 3, wherein said undercoat application areas are made adjustable in size.

5. The method of applying an undercoat in an ink jet recording apparatus as set forth in claim 2, wherein said undercoat application areas are made adjustable in size.

6. The method of applying an undercoat in an ink jet recording apparatus as set forth in claim 1, wherein said undercoat application areas are made adjustable in size.
